(19) United States
(12) Patent Application Publication
(10) Pub. No.: US 2016/0349604 A1
(43) Pub. Date: Dec. 1, 2016

(54) PROJECTION IMAGE DISPLAY APPARATUS

(71) Applicant: Panasonic Intellectual Property Management Co., Ltd., Osaka (JP)

(72) Inventor: MANABU OKUNO, Osaka (JP)

(21) Appl. No.: 15/140,475

(22) Filed: Apr. 28, 2016

(30) Foreign Application Priority Data
May 26, 2015 (JP) 2015-105998
Apr. 19, 2016 (JP) 2016-083283

(51) Int. Cl. G03B 21/16; G03B 21/20; G03B 21/28; G03B 21/00

(52) U.S. Cl. CPC G03B 21/16; G03B 21/008; G03B 21/204; G03B 21/28

(57) ABSTRACT

The projection image display apparatus comprises an illumination optical system for radiating illumination light, an optical modulator element for modulating the illumination light supplied from the illumination optical system based on an image signal and emitting the modulated light as image light, a TIR (Total Internal Reflecting) prism formed of a first prism and a second prism and a heat dissipating member mounted on a lateral face of the first prism. The first prism has an illumination-light reflecting face that reflects the illumination light. The second prism has an image-light entry face that receives the image light. The illumination-light reflecting face confronts the image-light entry face with a given space therebetween. The heat dissipating member is mounted to at least one of two lateral faces excluding an illumination-light entry face that receives the illumination light, the illumination-light reflecting face, and a transmission face through which the illumination light and the image light pass of the first prism.

### TECHNICAL FIELD

The present disclosure relates to a projection image display apparatus that projects an image on a screen.

### BACKGROUND ART

A projection image display apparatus, which employs a digital micro-mirror device (hereinafter referred to simply as DMD) as an optical modulator element, has been available in the market. The projection image display apparatuses have been sophisticated, so that a higher resolution as well as a higher brightness has been required. To obtain the higher brightness, the DMD is irradiated with intense illumination light, and the DMD absorbs the light, so that a temperature of the DMD rises. To overcome this problem, the DMD is equipped with a cooling structure to cool the DMD.

Patent literature 1 discloses a structure for cooling an image display element and a prism. This disclosed projection image display apparatus includes a cooling structure that can cool not only the image display element but also the prism, so that both of the image display element and the prism can be cooled.

### RELATED ART LITERATURE

Patent Literature 1: International Publication No. 02/19027

### SUMMARY

The present disclosure provides a projection image display apparatus that allows reducing thermal distortion on the prism caused by a higher brightness and yet allows projecting a quality image on a screen.

The projection image display apparatus in accordance with the present disclosure comprises the following structural elements:
an illumination optical system for radiating illumination light;
an optical modulator element for modulating, based on an image signal, the illumination light supplied from the illumination optical system, and emitting the modulated light as image light;
a TIR (Total Internal Reflecting) prism formed of a first prism and a second prism; and
a heat dissipating member mounted on a lateral face of the first prism.

The first prism has an illumination-light reflecting face that reflects the illumination light. The second prism has an image-light entry face that receives the image light. The illumination-light reflecting face confronts the image-light entry face with a given space therebetween. The heat dissipating member is mounted to at least one of two lateral faces excluding an illumination-light entry face that receives the illumination light, the illumination-light reflecting face, and a transmission face through which the illumination light and the image light pass of the first prism.

The projection image display apparatus in accordance with the present disclosure allows reducing thermal distortions on the prism, and achieving a quality image at a higher brightness.

### BRIEF DESCRIPTION OF THE DRAWINGS

FIG. 1 shows an overall structure of a projection image display apparatus in accordance with an embodiment of the present disclosure.

FIG. 2 shows a fluorescent wheel device used in the embodiment.

FIG. 3 is a schematic diagram illustrating an essential part of the projection image display apparatus in accordance with the embodiment.

FIG. 4 is a schematic diagram illustrating structures of a heat dissipating member, heat conductive member, and a prism in accordance with the embodiment.

FIG. 5 is a schematic diagram illustrating an exploded view of the heat dissipating member, heat conductive member, and the prism in accordance with the embodiment.

FIG. 6 is a schematic diagram illustrating an essential part of a projection image display apparatus in accordance with another embodiment of the present disclosure.

### DETAILED DESCRIPTION OF PREFERRED EMBODIMENTS

The embodiments of the present disclosure are detailed hereinafter with reference to the accompanying drawings. Descriptions more than necessary are sometimes omitted. For instance, detailed descriptions of the subjects already in the public domain, or duplicated descriptions of substantially the same structures are omitted here, in order to avoid redundancy in the descriptions below, and to allow the ordinary skilled persons in the art to understand the descriptions with ease.

The accompanying drawings and the descriptions below are provided for the ordinary skilled persons in the art to understand the present disclosure, so that the scope of the claims is not limited by these materials.

### Exemplary Embodiment

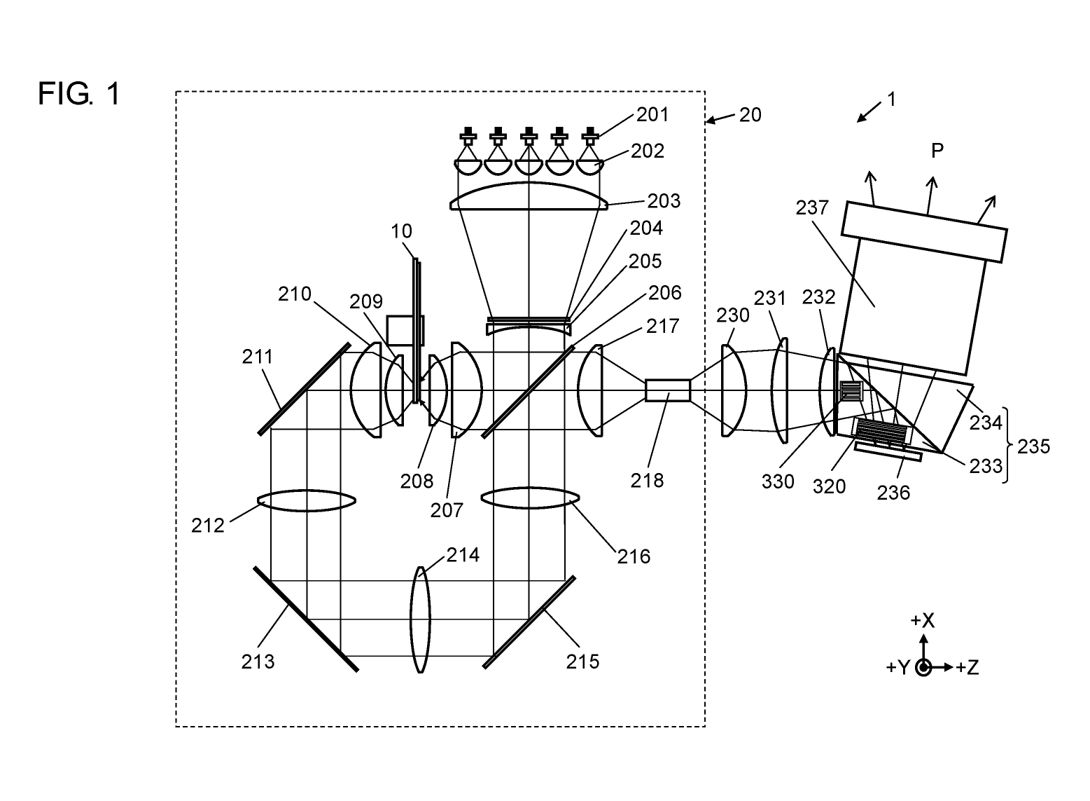

An exemplary embodiment of the present disclosure is demonstrated hereinafter with reference to FIG. 1-FIG. 5.

### 1-1. Structure

### 1-1-1. Overall Structure

FIG. 1 illustrates a structure of an optical system of projection image display apparatus 1 in accordance with the present disclosure, and this projection image display apparatus 1 includes fluorescent wheel device 10. In order to express the description simply, an XYZ orthogonal coordinate system is used in FIG. 1.

First, illumination optical system 20 of projection image display apparatus 1 is demonstrated hereinafter. Laser light source 201, which is an excitation light source, is a semiconductor laser in blue color, and is formed of multiple semiconductor lasers to achieve an illumination device of high brightness. In FIG. 1, five semiconductor lasers in blue color are disposed side by side as an example, and in general, multiple semiconductor lasers are disposed on a plane in matrix. Each of the laser light, which is excitation light outgoing from each of laser light sources 201, is collimated by corresponding collimator lens 202. The light emitted from collimator lens 202 travels approx. in parallel to each other. The entire light beam including the light travelling in parallel is converged by lens 203, then passes through diffuser panel 204. The light is then collimated into parallel light again by lens 205. The laser beam thus collimated into approx. parallel light by lens 205 then enters dichroic mirror 206 disposed at approx. 45 degrees with respect to the optical axis.

Diffuser panel 204 is made from flat glass, on which first surface peaks and valleys are finely formed to diffuse the light. Dichroic mirror 206 reflects the light of which wavelength falls within the wave range of the semiconductor laser in blue color, but allows the light outside this wave range to transmit therethrough.

The laser light entering dichroic mirror 206 in −X direction reflects from dichroic mirror 206, and then outgoes in —Z direction. The laser light is then converged by lens 207 and lens 208 before exciting the fluorescent applied on fluorescent wheel device 10.

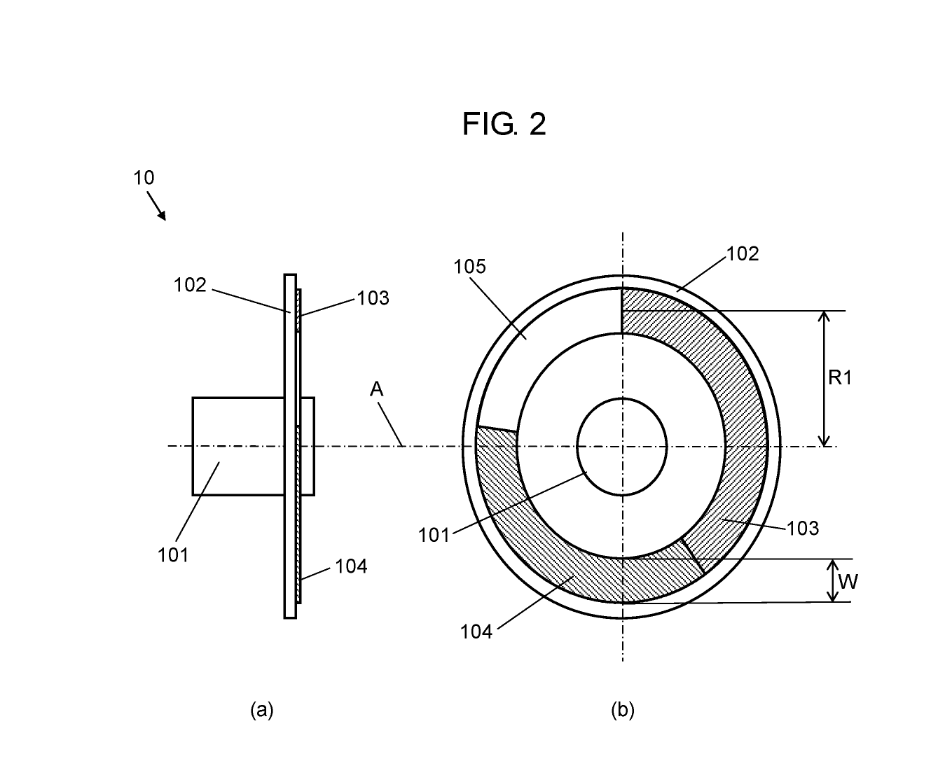

Fluorescent wheel device 10 includes motor 101, and rotary member 102 that is rotated on a rotary shaft of motor 101 and formed of a disc-shaped panel as shown in a lateral view (a) of FIG. 2.

As shown in a front view (b) of FIG. 2, depicts, rotary member 102 includes red phosphor section 103, green phosphor section 104, and opening section 105 on the circumference spaced away by distance R1 from rotary shaft center A of rotary member 102. Each of these three sections has width W across the circumference.

Convergence of the laser light supplied from laser light source 201 onto red phosphor section 103 of fluorescent wheel device 10 causes red phosphor section 103 to be excited and to emit red color. Convergence of the laser light supplied from laser light source 201 onto green phosphor section 104 of fluorescent wheel device 10 causes green phosphor section 104 to be excited and to emit green color. On top of that, the laser light supplied from laser light source 201 converges onto opening section 105 and passes through fluorescent wheel device 10.

Back to FIG. 1, the red light and the green light generated in fluorescent wheel device 10 emit therefrom in +Z direction. The phosphorous light emits in −Z direction from red phosphor section 103 and green phosphor section 104, and reflects from rotary member 102 before outgoing in +Z direction. These red light and green light are collimated into parallel light through lens 208 and lens 207, then pass through dichroic mirror 206, and are converged by condenser lens 217 before entering rod integrator 218.

On the other hand, the blue light, having passed through opening section 105, of the semiconductor laser in blue color travels through lens 209, lens 210, mirror 211, lens 212, mirror 213, lens 214, mirror 215, and lens 216, then reflects from dichroic mirror 206, and is converged by condenser lens 217 before entering rod integrator 218. Lenses 212, 214, and 216 work as a relay lens.

The light outgoing from rod integrator 218 travels through lens 230, lens 231, lens 232, and enters TIR (Total Internal Reflecting) prism 235 that is formed of a pair of prisms (i.e. first prism 233 and second prism 234). Then this incident light is modulated with an image signal in DMD (Digital Micro-mirror Device) 236 that works as an optical modulator element, and outgoes as image light P. Lenses 230, 231 work as a relay lens, and lens 232 receives the light emitted from a light outgoing face of rod integrator 318, thereby forming an image on DMD 236.

The light outgoing from DMD 236 enters projection lens 237, and the outgoing light from projection lens 237 is projected as image light P onto a screen with magnification.

### 1-1-2. Structures of Essential Parts

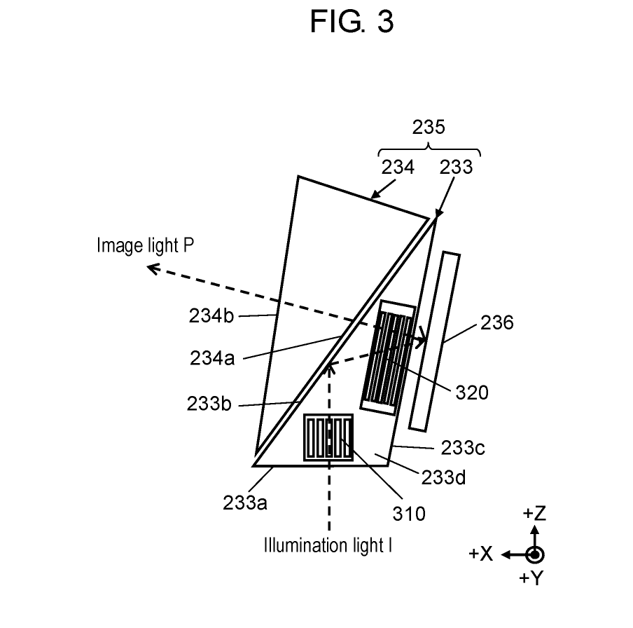

FIG. 3 is a schematic view of an essential part of projection image display apparatus 1 in accordance with the embodiment. TIR prism 235 is formed of first prism 233 and second prism 234. Each of prisms 233 and 234 is shaped like a triangular pole. First prism 233 confronts second prism 234 in such a manner that illumination-light reflecting face 233b, which reflects illumination light I converged by lens 232, confronts image-light entry face 234a, which receives image light P emitted from DMD 236, with an air-layer having a given thickness therebetween. First prism 233 has an inner absorption ratio equal to or less than 1% at a thickness of 10 mm with respect to the light having a wavelength falling within a range of 380 nm-780 nm.

As FIG. 3 shows, illumination light I converged by lens 232 shown in FIG. 1 passes through illumination-light entry face 233a of first prism 233, then totally reflects from illumination-light reflecting face 233b, and outgoes from transmission face 233c. Illumination light I passes through transmission face 233c, then enters DMD 236, in which illumination light I is modulated based on an image signal, and the resultant light outgoes as image light P, which then enters first prism 233 at transmission face 233c, passes through illumination-light reflecting face 233b, and then travels through image-light entry face 234a and light-outgoing face 234b of second prism 234.

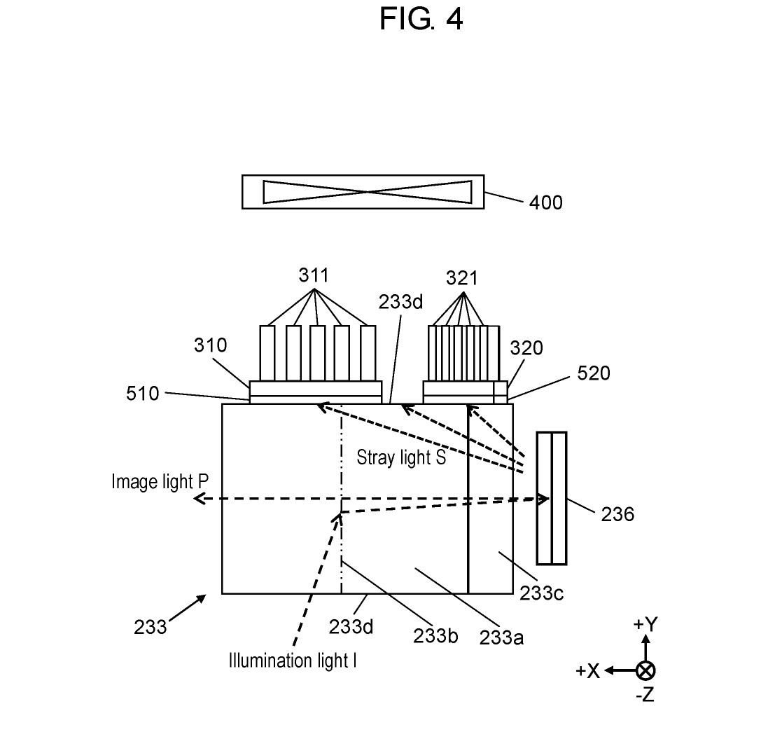

As FIG. 4 shows, first heat sink 310 and second heat sink 320 are mounted to lateral face 233d of first prism 233 that is a part of TIR prism 235. Lateral face 233d includes two faces out of the faces of first prism 233 excluding illumination-light entry face 233a, illumination-light reflecting face 233b, and transmission face 233c through which illumination light I and image light P pass. First heat sink 310 and second heat sink 320 are examples of the heat dissipating member.

As FIG. 3 shows, first heat sink 310 is disposed on lateral face 233d of first prism 233 at a place close to illumination-light entry face 233a in such a manner that first heat sink 310 overlaps a projected optical axis on lateral face 233d of illumination light I, which travels from illumination-light entry face 233a to illumination-light reflecting face 233b. As FIG. 3 shows, second heat sink 320 is disposed on lateral face 233d of first prism 233 at a place close to transmission face 233c in such a manner that second heat sink 320 overlaps a projected optical axis on lateral face 233d of illumination light I, which travels from illumination-light reflecting face 233b to transmission face 233c.

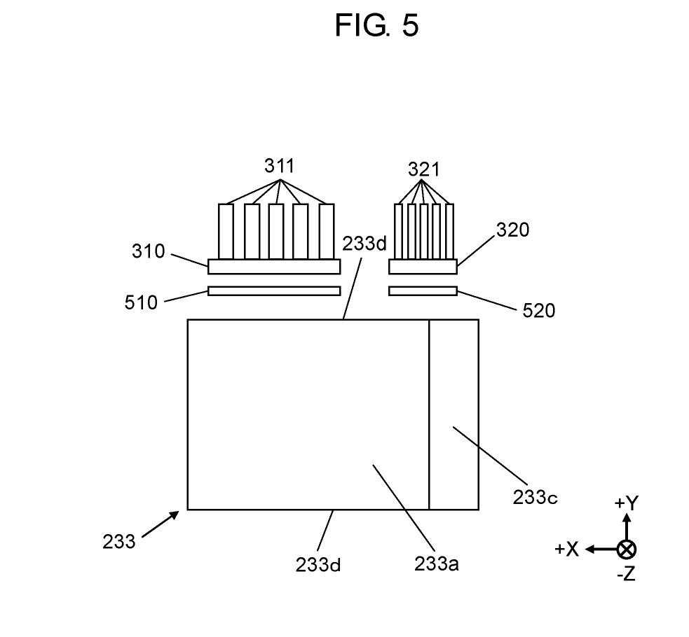

FIG. 4 illustrates schematically the state of first heat sink 310 and second heat sink 320 mounted to first prism 233, and FIG. 5 shows an exploded view of this mounted state.

As FIG. 4 shows, heat conductive sheet 510 is disposed between first prism 233 and first heat sink 310. Heat conductive sheet 520 is disposed between first prism 233 and second heat sink 320. Both of heat conductive sheets 510 and 520 have heat conductivity equal to 0.1 W/m·K or more, and reflection factor equal to 90% or less.

Heat conductive sheets 510 and 520 can be made from, for instance, fuse-change sheet because this sheet satisfies the heat conductivity and reflection factor discussed above, and yet, this sheet has adhesion. Use of the fuse-change sheet thus allows the two heat sinks to adhere onto first prism 233 without using adhesive. Heat conductive sheets 510 and 520 are examples of the heat conductive member.

In this embodiment, in order to obtain greater heat dissipation effect, first heat sink 310 includes multiple heat-sink fins 311, and second heat sink 320 also includes multiple heat-sink fins 321. Cooling fan 400 is disposed such that the cooling air blows against these heat-sink fins 311 and 321. Cooling fan 400 is a device for blowing the cooling air to first heat sink 310 and second heat sink 320. The cooling air is blown in −Y direction shown in FIG. 4.

Since first prism 233 has the inner absorption properties, illumination light I turns into heat when passing through first prism 233, so that the temperature of first prism 233 rises. A rise in temperature of first prism 233 causes thermal expansion on first prism 233 and generates thermal distortion. Heat absorption of 2 watts (W) by first prism 233 generates a distortion on illumination-light reflecting face 233b of first prism 233 such that the distortion amount is 1 μm height-change in every 10 μm width. The thermal distortion in first prism 233 causes positional slippages among DMD 236, first prism 233, second prism 234, and projection lens 237, so that the quality of an image projected with magnification on the screen is degraded.

To overcome this problem, this embodiment employs the structure below: The heat generated in first prism 233 travels through heat conductive sheets 510 and 520 before arriving at first heat sink 310 and second heat sink 320, and the heat arriving at these heat sinks is cooled by cooling fan 400.

This structure allows preventing the temperature in first prism 233 from rising, so that the thermal distortion on first prism 233 can be reduced. The positional slippage of first prism 233 can be thus reduced, and the image quality on the screen is improved.

As FIG. 4 shows, the light beam of illumination light I and stray light S that is generated from a light beam of image light P emitted from DMD 236, pass through first prism 233, and radiate onto lateral face 233d of first prism 233. A part of stray light S radiates onto heat conductive sheets 510 and 520. When stray light S enters heat conductive sheets 510 and 520, heat conductive sheets 510 and 520 absorb greater than 10% of stray light S because a reflection factor of heat conductive sheets 510 and 520 is 90% or less. This mechanism allows reducing an amount of stray light S to be projected on the screen through projection lens 237.

Heat conductive sheets 510, 520 preferably include volatile constituent as little as possible, so that an amount of the volatile constituent adhering to the optical members can be reduced. The amount of volatile constituent is preferably 0.2% or less under the circumference of 150° C. and after the lapse of 24 hours.

In this embodiment, first heat sink 310 and second heat sink 320 are mounted to only first prism 233 of TIR prism 235. Because image light P emitted from DMD 236 simply passes through second prism 234, and yet, image light P uses a part of illumination light I, whereby heat generation in second prism 234 is so little that no worry is needed.

### 1-2. Advantage

The embodiment proves that the heat generated by the illumination light I radiating onto DMD 236 can be efficiently dissipated from TIR prism 235 by first heat sink 310 and second heat sink 320, thereby reducing the thermal distortion in TIR prism 235. This structure allows improving a quality of an image projected with magnification on the screen. Since a heat conductive sheet of which reflection factor is 90% or less is used for the heat sink to adhere to the prism, the heat conductive sheet can absorb 10% or more of the stray light entering there. The stray light can be thus reduced for improving the quality of image on the screen.

### Other Embodiments

The foregoing embodiment is an example of the technique disclosed in the present disclosure; however, the technique is not limited to this embodiment, and is applicable to embodiments in which changes, replacements, additions, and omissions are carried out in the foregoing embodiment. Structural elements of the embodiment can be combined to establish other embodiments, which are demonstrated hereinafter as examples.

The heat sinks are used as the heat dissipating member in the foregoing embodiment; however, the heat dissipating member is not limited to the heat sink. For instance, use of a Peltier element and a heat sink as the heat dissipating member will generate greater effect of reducing thermal distortion on the prism. The heat conductive sheet can employ other adhesive members than the fuse-change sheet. Use of the heat conductive member as a bonding means will produce heat dissipation effect.

The heat sinks are mounted to one of the lateral faces of first prism 233 in the foregoing embodiment; however, the heat sinks can be mounted to both of the lateral faces. This structure increases the heat dissipation effect of the prism, and decreases the thermal distortion.

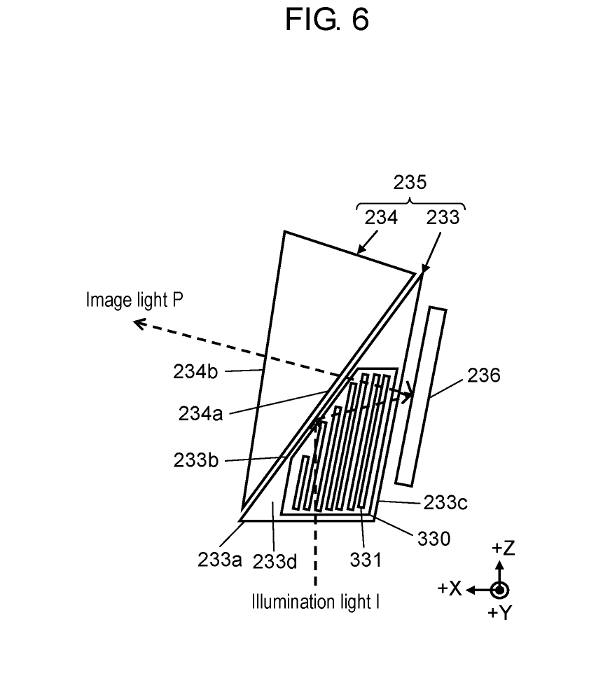

In the foregoing embodiment, two heat sinks (first heat sink 310 and second heat sink 320) are used as the heat dissipating member; however, they can be integrated into one heat sink 330 as shown in FIG. 6. This structure allows employing heat-sink fins 331 in a greater size, so that the heat dissipation effect of the prism can be increased and the thermal distortion can be further reduced.

These embodiments discussed above are examples of the technique disclosed in the present disclosure, so that various changes, replacements, additions, and omissions can be carried out in the scope of the claims or in an equivalent scope thereto.

### INDUSTRIAL APPLICABILITY

The present disclosure is applicable to projection image display apparatuses such as a projector.

What is claimed is:

1. A projection image display apparatus comprising:
an illumination optical system for radiating illumination light;
an optical modulator element for modulating, based on an image signal, the illumination light supplied from the illumination optical system, and emitting the modulated light as image light;
a total internal reflecting (TIR) prism including a first prism and a second prism, the first prism having an illumination-light reflecting face that reflects the illumination light, the second prism having an image-light entry face that receives the image light, the illumination-light reflecting face confronting the image-light entry face with a given space therebetween; and
a heat dissipating member mounted to at least one of two lateral faces excluding an illumination-light entry face that receives the illumination light, the illumination-light reflecting face, and a transmission face through which the illumination light and the image light pass of the first prism.

2. The projection image display apparatus according to claim 1, further comprising a fan for blowing air to the heat dissipating member.

3. The projection image display apparatus according to claim 1, further comprising a heat conductive member between the first prism and the heat dissipating member, the heat conductive member having a heat conductivity of 0.1 W/m·K or more.

4. The projection image display apparatus according to claim 3, wherein the heat conductive member has a reflecting factor of 90% or less with respect to light of which wavelength falls within a range from 380 nm to 780 nm.

5. The projection image display apparatus according to claim 3, wherein the heat conductive member volatilizes in an amount of 0.2% or less in an environment of 150° C. and after a lapse of 24 hours.

6. The projection image display apparatus according to claim 1, further comprising a plurality of the heat dissipating members,
wherein at least one of the heat dissipating members is disposed at a place where the at least one heat dissipating member overlaps an optical axis projected on the at least one of two lateral faces, the optical axis being of the illumination light traveling from the illumination-light entry face to the illumination-light reflecting face, and
wherein at least another one of the heat dissipating members is disposed at a place where the at least another heat dissipating member overlaps an optical axis projected on the at least one of two lateral faces, the optical axis being of the illumination light traveling from the illumination-light reflecting face to the transmission face.
